(19) United States
(12) Patent Application Publication
(10) Pub. No.: US 2012/0148768 A1
(43) Pub. Date: Jun. 14, 2012

(54) TRANSPARENT INK-JET RECORDING FILMS, COMPOSITIONS, AND METHODS

(76) Inventors: Sharon M. Simpson, Lake Elmo, MN (US); William D. Devine, Fort Collins, CO (US); James L. Johnston, Brighton, CO (US); William J. Ruzinsky, Loveland, CO (US); Heidy M. Vosberg, Lake Elmo, MN (US); Eric J. Adsit, Fort Collins, CO (US)

(21) Appl. No.: 13/309,614

(22) Filed: Dec. 2, 2011

Related U.S. Application Data
(60) Provisional application No. 61/421,300, filed on Dec. 9, 2010.

(51) Int. Cl. B41M 5/52

(52) U.S. Cl. 428/32.28; 428/32.34

(57) ABSTRACT

Transparent ink-jet recording films, compositions, and methods are disclosed. These compositions and methods can impart excellent adhesion properties between film layers and the transparent support. The films have improved appearance compared to similar high optical density films. Such improved appearance films are produced without requiring reduced drying process throughput. These films are useful for medical imaging.

### CROSS REFERENCE TO RELATED APPLICATIONS

This application claims the benefit of U.S. Provisional Patent No. 61/421,300, filed Dec. 9, 2010, entitled TRANSPARENT INK-JET RECORDING FILMS, COMPOSITIONS, AND METHODS, which is hereby incorporated by reference in its entirety.

### SUMMARY

Transparent ink-jet recording films often employ one or more layers, such as under-layers or image-receiving layers, on one or both sides of a transparent support. For medical applications, it is important that these layers not easily peel off of the transparent support during the lifetime of the product. The compositions and methods of the present application can impart excellent adhesion properties between these layers and the transparent support.

In order to obtain high image densities when printing on transparent films, more ink is often applied than is required for opaque films. To be able to accommodate more printing ink, image-receiving layer thicknesses may be increased relative to those in opaque films. However, such a change generally increases the amount of liquids that need to be removed during the drying stages of the transparent film manufacturing process. Moving to more aggressive drying conditions to compensate can cause undesirable patterns to form on the film. However, use of mild drying conditions that minimize such pattern formation can adversely impact process throughput. The compositions and methods of the present application can reduce such patterning without requiring reduced drying process throughput.

At least some embodiments provide a transparent ink-jet recording film comprising a transparent substrate comprising a polyester; at least one subbing layer disposed on the transparent substrate, where the at least one subbing layer comprises gelatin, at least one polymeric matting agent, and at least one borate or borate derivative; and at least one image-receiving layer disposed on the at least one subbing layer, where the at least one image-receiving layer comprises at least one inorganic particle and at least one water soluble or water dispersible polymer comprising at least one hydroxyl group.

In some embodiments, the transparent ink-jet recording film further comprises at least one primer layer disposed between the transparent substrate and the at least one subbing layer, where the at least one primer layer comprises at least one latex polymer and at least one adhesion promoter. In at least some embodiments, the at least one adhesion promoter comprises resorcinol.

In at least some embodiments, the at least one polymeric matting agent may comprise recurring units comprising methyl methacrylate, the at least one borate or borate derivative may comprise sodium tetraborate decahydrate, the at least one water soluble or water dispersible polymer may comprise poly(vinyl alcohol), or the at least one inorganic particles may comprise boehmite alumina.

These embodiments and other variations and modifications may be better understood from the description, exemplary embodiments, examples, and claims that follow. Any embodiments provided are given only by way of illustrative example. Other desirable objectives and advantages inherently achieved may occur or become apparent to those skilled in the art. The invention is defined by the appended claims.

### DESCRIPTION

All publications, patents, and patent documents referred to in this document are incorporated by reference herein in their entirety, as though individually incorporated by reference.

U.S. Provisional Patent No. 61/421,300, filed Dec. 9, 2010, entitled TRANSPARENT INK-JET RECORDING FILMS, COMPOSITIONS, AND METHODS, is hereby incorporated by reference in its entirety.

### Introduction

An ink-jet recording film may comprise at least one image-receiving layer, which receives ink from an ink-jet printer during printing, and a substrate or support, which may be opaque or transparent. An opaque support may be used in films that may be viewed using light reflected by a reflective backing, while a transparent support may be used in films that may be viewed using light transmitted through the film.

Some medical imaging applications required high image densities. For a reflective film high image densities may be achieved by virtue of the light being absorbed on both its path into the imaged film and again on the light's path back out of the imaged film from the reflective backing. On the other hand, for a transparent film, because of the lack of a reflective backing, achievement of high image densities may require application of larger quantities of ink thank are common for opaque films. In such cases, larger quantities of liquids must generally be removed during the drying stages of the transparent film manufacturing process, which can impact both the quality of the dried film and the throughput of the drying process.

### Transparent Ink-Jet Films

Transparent ink-jet recording films are known in the art. See, for example, U.S. provisional patent application Ser. No. 13/176,788, “TRANSPARENT INK-JET RECORDING FILM,” by Simpson et al., filed Jul. 6, 2011, and U.S. provisional patent application Ser. No. 13/208,379, “TRANSPARENT INK-JET RECORDING FILMS, COMPOSITIONS, AND METHODS,” by Simpson et al., filed Aug. 12, 2011, both of which are herein incorporated by reference in their entirety.

Transparent ink-jet recording films may comprise one or more transparent substrates. In some embodiments, the film may comprise at least one primer layer coated upon the one or more transparent substrates and at least one subbing layer coated upon the at least one primer layer. In other embodiments, the film may comprise at least one subbing layer coated upon the one or more transparent substrates. Such a subbing layer may optionally be dried before being further processed. In still other embodiments, the film may comprise at least one subbing layer coated upon both the at least one primer layer and the one or more transparent substrates.

Such ink-jet recording films may further comprise one or more image-receiving layers coated upon at least one subbing layer. Such an image-receiving layer is generally dried after coating. The film may optionally further comprise additional layers, such as one or more backing layers or overcoat layers, as will be understood by those skilled in the art.

Applicants have discovered that such transparent ink-jet films can exhibit superior drying after ink-jet printing, with superior adhesion of the layers to the transparent substrate. Moreover, such films can exhibit higher light transmission and lower haze than films with similar drying and adhesion properties.

### Transparent Substrate

Transparent substrates may be flexible, transparent films made from polymeric materials, such as, for example, polyethylene terephthalate, polyethylene naphthalate, cellulose acetate, other cellulose esters, polyvinyl acetal, polyolefins, polycarbonates, polystyrenes, and the like. In some embodiments, polymeric materials exhibiting good dimensional stability may be used, such as, for example, polyethylene terephthalate, polyethylene naphthalate, other polyesters, or polycarbonates.

Other examples of transparent substrates are transparent, multilayer polymeric supports, such as those described in U.S. Pat. No. 6,630,283 to Simpson, et al., which is hereby incorporated by reference in its entirety. Still other examples of transparent supports are those comprising dichroic mirror layers, such as those described in U.S. Pat. No. 5,795,708 to Boutet, which is hereby incorporated by reference in its entirety.

Transparent substrates may optionally contain colorants, pigments, dyes, and the like, to provide various background colors and tones for the image. For example, a blue tinting dye is commonly used in some medical imaging applications. These and other components may optionally be included in the transparent substrate, as will be understood by those skilled in the art.

In some embodiments, the transparent substrate may be provided as a continuous or semi-continuous web, which travels past the various coating, drying, and cutting stations in a continuous or semi-continuous process.

### Substrate Treatments

In some embodiments, the surface of the transparent substrate may be treated to improve adhesion to adjacent layers of the film. Such surface treatments may include, but are not limited to, chemical treatment, mechanical treatment, corona discharge, flame treatment, UV irradiation, radio-frequency treatment, glow discharge, plasma treatment, acid treatment, ozone oxidation, electron beam treatment, and the like. These and other such surface treatments are known to those of skill in the art.

### Primer Layers

In some embodiments, one or more primer layers may be used to improve adhesion of the transparent substrate to other layers. Generally, such primer layers, when present, are adjacent to the substrate surface, with the other layers disposed on the primer layers. Primer layers may be used in combination with or in lieu of treatment of the substrate surface. In some embodiments, a primer layer may comprise a coating thickness of about 0.112 g/m² on a dry basis.

Such primer layers may comprise adhesion promoters, such as phenolic or naphtholic compounds substituted with one or more hydroxyl groups, including but not limited to, for example, phenol, resorcinol, orcinol, catechol, pyrogallol, 2,4-dinitrophenol, 2,4,6-trinitrophenol, 4-chlororesorcinol, 2,4-dihydroxy toluene, 1,3-naphthalenediol, the sodium salt of 1-naphthol-4-sulfonic acid, o-fluorophenol, m-fluorophenol, p-fluorophenol, o-cresol, p-hydroxybenzotrifluoride, gallic acid, 1-naphthol, chlorophenol, hexyl resorcinol, chloromethylphenol, o-hydroxybenzotrifluoride, m-hydroxybenzotrifluoride, p-chloro-m-xylenol, and the like. Other examples of adhesion promoters include acrylic acid, benzyl alcohol, trichloroacetic acid, dichloroacetic acid, chloral hydrate, ethylene carbonate, and the like. These or other adhesion promoters may be used as a single adhesion promoter or as mixtures of two or more adhesion promoters.

Such primer layers may comprise one or more polymers. Often these include polymers of monomers having polar groups in the molecule such as carboxyl, carbonyl, hydroxy, sulfo, amino, amido, epoxy or acid anhydride groups, for example, acrylic acid, sodium acrylate, methacrylic acid, itaconic acid, crotonic acid, sorbic acid, itaconic anhydride, maleic anhydride, cinnamic acid, methyl vinyl ketone, hydroxyethyl acrylate, hydroxyethyl methacrylate, hydroxychloropropyl methacrylate, hydroxybutyl acrylate, vinylsulfonic acid, potassium vinylbenezensulfonate, acrylamide, N-methylamide, N-methylacrylamide, acryloylmorpholine, dimethylmethacrylamide, N-t-butylacrylamide, diacetonacrylamide, vinylpyrrolidone, glycidyl acrylate, or glycidyl methacrylate, or copolymers of the above monomers with other copolymerizable monomers. Additional examples are polymers of, for example, acrylic acid esters such as ethyl acrylate or butyl acrylate, methacrylic acid esters such as methyl methacrylate or ethyl methacrylate or copolymers of these monomers with other vinylic monomers; or copolymers of polycarboxylic acids such as itaconic acid, itaconic anhydride, maleic acid or maleic anhydride with vinylic monomers such as styrene, vinyl chloride, vinylidene chloride or butadiene, or trimers of these monomers with other ethylenically unsaturated monomers. Materials used in adhesion-promoting layers often comprise a copolymer containing a chloride group such as vinylidene chloride. In some embodiments, a terpolymer of monomers comprising about 83 wt % vinylidene chloride, about 15 wt % methyl acrylate, and about 2 wt % itaconic acid may be used, as described in U.S. Pat. No. 3,143,421 to Nadeau et al., which is hereby incorporated by reference in its entirety.

In some embodiments, the one or more polymers may be provided as a latex dispersion. Such a latex dispersion may be prepared by, for example, emulsion polymerization. In other embodiments, the one or polymers may be prepared by solution polymerization, followed by dispersion of the polymers in water to form a latex dispersion. Such polymers, when provided as a latex dispersion, may be referred to as latex polymers.

The one or more primer layer may optionally also comprise one or more surfactants, such as, for example, saponin. Such surfactants may be provided as part of one or more latex dispersions or may be provided in addition to any surfactants may be in such dispersions.

In some embodiments, the one or more primer layers may be applied to the transparent substrate prior to orientation of the substrate. Such orientation may comprise, for example, uniaxial or biaxial orientation at one or more temperatures above the glass transition temperature and below the melting temperature of the transparent substrate.

### Subbing Layers

The one or more subbing layers may be applied to a transparent substrate or to one or more primer layers disposed on a transparent substrate. Generally, such subbing layers, when present, are adjacent to the one or more primer layers, when present, or are adjacent to the substrate surface, when the one or more primer layers are absent. In some embodiments, for example, where the one or more primer layers do not completely cover the substrate surface, the one or more subbing layer may be adjacent to both that substrate surface and to the one or more primer layers. In some embodiments, a subbing layer may comprise a coating thickness of about 0.143 g/m² on a dry basis.

In some embodiments, the one or more subbing layers may comprise gelatin, such as, for example, Regular Type IV bovine gelatin, alkali-treated gelatin, acid-treated gelatin, phthalate-modified gelatin, vinyl polymer-modified gelatin, acetylated gelatin, deionized gelatin, and the like.

The one or more subbing layers may further comprise at least one borate or borate derivative, such as, for example, sodium borate, sodium tetraborate, sodium tetraborate decahydrate, boric acid, phenyl boronic acid, butyl boronic acid, and the like. More than one type of borate or borate derivative may optionally be included in the one or more subbing layers. In some embodiments, the borate or borate derivative may be used in an amount of up to, for example, about 2 g/m². In at least some embodiments, the ratio of the at least one borate or borate derivative to the gelatin may be between about 9:1 and about 4:1 by weight, or the ratio may be about 6.8:1 by weight.

Such subbing layers may further comprise one or more polymers. In some embodiments, such polymers may comprise polymers of monomers comprising polar groups in the molecule such as carboxyl, carbonyl, hydroxy, sulfo, amino, amido, epoxy or acid anhydride groups, for example, acrylic acid, sodium acrylate, methacrylic acid, itaconic acid, crotonic acid, sorbic acid, itaconic anhydride, maleic anhydride, cinnamic acid, methyl vinyl ketone, hydroxyethyl acrylate, hydroxyethyl methacrylate, hydroxychloropropyl methacrylate, hydroxybutyl acrylate, vinylsulfonic acid, potassium vinylbenezensulfonate, acrylamide, N-methylamide, N-methylacrylamide, acryloylmorpholine, dimethylmethacrylamide, N-t-butylacrylamide, diacetonacrylamide, vinylpyrrolidone, glycidyl acrylate, or glycidyl methacrylate, or copolymers of the above monomers with other copolymerizable monomers. Additional examples are polymers of, for example, acrylic acid esters such as ethyl acrylate or butyl acrylate, methacrylic acid esters such as methyl methacrylate or ethyl methacrylate or copolymers of these monomers with other vinylic monomers; or copolymers of polycarboxylic acids such as itaconic acid, itaconic anhydride, maleic acid or maleic anhydride with vinylic monomers such as styrene, vinyl chloride, vinylidene chloride or butadiene, or trimers of these monomers with other ethylenically unsaturated monomers. In some embodiments, materials used in adhesion-promoting layers comprise polymers of one or more monomers containing a chloride group such as vinylidene chloride. In some embodiments, subbing layers may comprise one or more polymers comprising one or more polymeric matting agents. Such polymeric matting agents are described in U.S. Pat. No. 6,555,301 to Smith et al., which is hereby incorporated by reference in its entirety.

Such subbing layers may comprise one of more hardeners or crosslinking agents. In some embodiments, such hardeners may include, for example, 1,2-bis(vinylsulfonylacetamido)ethane, bis(vinylsulfonyl)methane, bis(vinylsulfonylmethyl)ether, bis(vinylsulfonylethyl)ether, 1,3-bis(vinylsulfonyl)propane, 1,3-bis(vinylsulfonyl)-2-hydroxypropane, 1,1,-bis(vinylsulfonyl)ethylbenzenesulfonate sodium salt, 1,1,1-tris(vinylsulfonyl)ethane, tetrakis(vinylsulfonyl)methane, tris(acrylamido)hexahydro-s-triazine, copoly(acrolein-methacrylic acid), glycidyl ethers, acrylamides, dialdehydes, blocked dialdehydes, alpha-diketones, active esters, sulfonate esters, active halogen compounds, s-triazines, diazines, epoxides, formaldehydes, formaldehyde condensation products anhydrides, aziridines, active olefins, blocked active olefins, mixed function hardeners such as halogen-substituted aldehyde acids, vinyl sulfones containing other hardening functional groups, 2,3-dihydroxy-1,4-dioxane, potassium chrome alum, polymeric hardeners such as polymeric aldehydes, polymeric vinylsulfones, polymeric blocked vinyl sulfones and polymeric active halogens.

Such subbing layers may comprise one or more surfactants. In some embodiments, such surfactants may include, for example, anionic surface active agents such as alkali metal or ammonium salts of alcohol sulfuric acid of 8 to 18 carbon atoms; ethanolamine lauryl sulfate; ethylaminolauryl sulfate; alkali metal and ammonium salts of paraffin oil; alkali metal salts of aromatic sulfonic acid such as dodecane-1-sulfonic acid, octadiene-1-sulfonic acid or the like; alkali metal salts such as sodium isopropylbenzene-sulfate, sodium isobutylnaphthalenesulfate or the like; and alkali metal or ammonium salts of esters of sulfonated dicarboxylic acid such as sodium dioctylsulfosuccinate, disodium dioctadecylsulfosuccinate or the like; nonionic surface active agents such as saponin, sorbitan alkyl esters, polyethylene oxides, polyoxyethylene alkyl ethers or the like; cationic surface active agents such as octadecyl ammonium chloride, trimethyldosecyl ammonium chloride or the like; and high molecular surface active agents other than those above mentioned such as polyvinyl alcohol, partially saponified vinyl acetates, maleic acid containing copolymers, or the like.

Such subbing layers may be coated from, for example, aqueous mixes. In some embodiments, a portion of the water in such mixes may be replaced by one or more water miscible solvents. Such solvents may include, for example, ketones such as acetone or methyl ethyl ketone, alcohols such as ethanol, methanol, isopropanol, n-propanol, and butanol, and the like.

### Polymeric Matting Agents

In some embodiments, one or more subbing layers may comprise one or more polymers comprising one or more polymeric matting agents. Such polymeric matting agents are described in U.S. Pat. No. 6,555,301 to Smith et al., which is hereby incorporated by reference in its entirety. Polymeric matting agents may have an average particle sizes from, for example, about 1.2 to about 3 micrometers and glass transition temperatures of, for example, at least about 135° C. or of at least about 150° C., as indicated by, for example, the onset in the change of heat capacity as measured by differential scanning calorimetry at a scan rate of 20° C./min. In some embodiments, polymeric matting agents may comprise copolymers of (A) recurring units derived from one or more polyfunctional ethylenically unsaturated polymerizable acrylates or methacrylates, and (B) recurring units derived from one or more monofunctional ethylenically unsaturated polymerizable acrylates or methacrylates having only one polymerizable site. Such copolymers may have compositions comprising, for example, from about 10 to about 30 wt % of (A) recurring units and from about 70 to about 90 wt % of (B) recurring units. Such copolymers may have compositions comprising at least about 5 wt % (A) recurring units, or at least about 10 wt % (A) recurring units, or up to about 30 wt % (A) recurring units, or up to about 50 wt % (A) recurring units. Such copolymers may have compositions comprising at least about 50 wt % (B) recurring units, or at least about 70 wt % (B) recurring units, or up to about 90 wt % (B) recurring units or up to about 95 wt % (B) recurring units.

Ethylenically unsaturated monomers represented by (A) include ethylenically unsaturated polymerizable compounds that have two or more functional groups that can be polymerized or reacted to form crosslinking sites within the polymer matrix. Thus, such monomers are considered “polyfunctional” with respect to the moieties used for polymerization and crosslinking. Representative monomers of this type include but are not limited to, aromatic divinyl compounds (such as divinylbenzene, divinylnaphthalene, and derivatives thereof), diethylene carboxylate esters (that is, acrylate and methacrylates) and amides (such as ethylene glycol dimethacrylate, diethylene glycol dimethacrylate, triethylene glycol dimethacrylate, ethylene glycol diacrylate, diethylene glycol diacrylate, 1,6-hexanediol dimethacrylate, 1,6-hexanediol diacrylate, pentaerythritol tetraacrylate, neopentyl glycol dimethacrylate, allyl methacrylate, allyl acrylate, butenyl acrylate, undecenyl methacrylate, 1,4-butanediol dimethacrylate, trimethylol propane trimethacrylate, trimethylol propane triacylate, 1,3-dibutanediol dimethacrylate, methylene-bisacrylamide, and hexamethylene-bisacrylamide), dienes (such as butadiene and isoprene), other divinyl compounds such as divinyl sulfide and divinyl sulfone compounds, and other compounds that would be readily apparent to one skilled in the art. Two or more of these monomers can be used to prepare matting agents. The polyfunctional acrylates and methacrylates described above are preferred in the practice of this invention. Ethylene glycol dimethacrylate, 1,6-hexanediol dimethacrylate, 1,6-hexanediol diacrylate, trimethylol propane trimethacrylate, and trimethylol propane triacrylate are particularly preferred. Ethylene glycol dimethacrylate is most preferred.

Ethylenically unsaturated monomers represented by (B) include polymerizable compounds that only one functional group that can be polymerized or reacted to form crosslinking sites within the polymer matrix. These include any other known monomer that can be polymerized in suspension polymerization with the monomers defined by the (A) recurring units. Such monomers include but are not limited to, ethylenically unsaturated hydrocarbons (such as ethylene, propylene, 1-butene, isobutene, styrene, α-methylstyrene, m-chloromethylstyrene, vinyl toluene, vinyl naphthalene, p-methoxystyrene, and hydroxymethylstyrene), ethylenically unsaturated esters of carboxylic acids (such as vinyl acetate, vinyl propionate, vinyl benzoate, vinyl cinnamate, and vinyl butyrate), esters of ethylenically unsaturated mono- or dicarboxylic acid amides (such as acrylamide, methacrylamide, N-methylacrylamide, N-ethylacrylamide, N,N-dimethylacrylamide, N-n-butylacrylamide, N-t-butylacrylamide, itaconic acid diamide, acrylamido-2,2-dimethylpropanesulfonic acid, N-isopropylacrylamide, N-acryloylmorpholine, and N-acryloylpiperidine), monoethylenically unsaturated dicarboxylic acids and their salts (such as acrylic acid, methacrylic acid, itaconic acid, and their salts), monoethylenically unsaturated compounds such as acrylonitrile and methacrylonitrile, vinyl halides (such as vinyl chloride, vinyl fluoride, and vinyl bromide), vinyl ethers (such as vinyl methyl ether, vinyl isobutyl ether, and vinyl ethyl ether), vinyl ketones (such as vinyl methyl ketone, vinyl hexyl ketone, and methyl isopropenyl ketone), acrolein, vinylidene halides (such as vinylidene chloride and vinylidene chlorofluoride), N-vinyl compounds (such as N-vinyl pyrrolidone, N-vinyl pyrrole, N-vinyl carbazole, and N-vinyl indole), and alkyl or aryl esters, amides, and nitriles (that is acrylates and methacrylates, such as methyl methacrylate, methyl acrylate, ethyl methacrylate, ethyl acrylate, n-butyl methacrylate, isobutyl methacrylate, 2-hydroxyethyl acrylate, 2-hydroxyethyl methacrylate, hexyl acrylate, hexyl methacrylate, 2-ethylhexyl acrylate, nonyl methacrylate, benzyl methacrylate, 2-hydroxypropyl methacrylate, and amides and nitriles of the same acids), and other compounds that would be understood to one skilled in the art. Mixtures of such monomers can also be used. Acrylates and methacrylates are preferred monomers for obtaining the (B) recurring units. Methyl methacrylate, isobutyl methacrylate, and methyl acrylate are particularly preferred and methyl methacrylate is most preferred.

In some embodiments, polymeric matting agents are prepared using one or more polyfunctional acrylates or methacrylates and one or more monofunctional acrylates or methacrylates. Representative useful polymers are as follows (having weight ratios within the previously described ranges): poly(methyl methacrylate-co-ethylene glycol dimethacrylate), poly(methyl methacrylate-co-1,6-hexanediol diacrylate), poly(methyl acrylate-co-trimethylol propane triacrylate), poly(isobutyl methacrylate-co-ethylene glycol dimethacrylate), and poly(methyl acrylate-co-1,6-hexanediol diacrylate).

### Image-Receiving Layer Coating Mix

Image-receiving layers may be formed by applying at least one image-receiving layer coating mix to one or more subbing layers. The image-receiving coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the at least one water soluble or water dispersible polymer may be used in an amount of up to about 1.0 to about 4.5 g/m², as measured in the image-receiving layer.

The image-receiving layer coating mix may also comprise at least one inorganic particle, such as, for example, metal oxides, hydrated metal oxides, boehmite alumina, clay, calcined clay, calcium carbonate, aluminosilicates, zeolites, barium sulfate, and the like. Non-limiting examples of inorganic particles include silica, alumina, zirconia, and titania. Other non-limiting examples of inorganic particles include fumed silica, fumed alumina, and colloidal silica. In some embodiments, fumed silica or fumed alumina have primary particle sizes up to about 50 nm in diameter, with aggregates being less than about 300 nm in diameter, for example, aggregates of about 160 nm in diameter. In some embodiments, colloidal silica or boehmite alumina have particle size less than about 15 nm in diameter, such as, for example, 14 nm in diameter. More than one type of inorganic particle may optionally be included in the image-receiving coating mix.

In at least some embodiments, the ratio of inorganic particles to polymer in the at least one image-receiving layer coating mix may be, for example, between about 88:12 and about 95:5 by weight, or the ratio may be about 92:8 by weight.

Image-receiving layer coating layer mixes prepared from alumina mixes with higher solids fractions can perform well in this application. However, high solids alumina mixes can, in general, become too viscous to be processed. It has been discovered that suitable alumina mixes can be prepared at, for example, 25 wt % or 30 wt % solids, where such mixes comprise alumina, nitric acid, and water, and where such mixes comprise a pH below about 3.09, or below about 2.73, or between about 2.17 and about 2.73. During preparation, such alumina mixes may optionally be heated, for example, to 80° C.

The image-receiving coating layer mix may also comprise one or more surfactants such as, for example, a nonyl phenol, glycidyl polyether; a fluoroacrylic alcohol substituted polyethylene; a hydroxy-terminated fluorinated polyether; or a non-ionic fluorosurfactant. In some embodiments, such a surfactant may be used in amount of, for example, about 1.5 g/m², as measured in the image-receiving layer. In some embodiments, the image-receiving coating layer may also optionally comprise one or more acids, such as, for example, nitric acid.

These and components may optionally be included in the image-receiving coating layer mix, as will be understood by those skilled in the art.

### Coating

The coated layers, such as, for example, primer layers, subbing layers, under-layers, image-receiving layers, back-coat layers, over-coat layers, and the like,. may be coated from mixes onto the transparent substrate. The various mixes may use the same or different solvents, such as, for example, water or organic solvents. Layers may be coated one at a time, or two or more layers may be coated simultaneously. For example, simultaneously with application of an under-layer coating mix to the support, an image-receiving layer may be applied to the wet under-layer using such methods as, for example, slide coating.

Layers may be coated using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety.

### Drying

Coated layers, such as, for example, primer layers, subbing layers, under-layers, image-receiving layers, back-coat layers, overcoat layers, and the like, may be dried using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety. In some embodiments, coating layers may be dried as they travel past one or more perforated plates through which a gas, such as, for example, air or nitrogen, passes. Such an impingement air dryer is described in U.S. Pat. No. 4,365,423 to After et al., which is incorporated by reference in its entirety. The perforated plates in such a dryer may comprise perforations, such as, for example, holes, slots, nozzles, and the like. The flow rate of gas through the perforated plates may be indicated by the differential gas pressure across the plates. The ability of the gas to remove water may be limited by its dew point, while its ability to remove organic solvents may be limited by the amount of such solvents in the gas, as will be understood by those skilled in the art.

### EXEMPLARY EMBODIMENTS

U.S. Provisional Patent No. 61/421,300, filed Dec. 9, 2010, entitled TRANSPARENT INK-JET RECORDING FILMS, COMPOSITIONS, AND METHODS, which is hereby incorporated by reference in its entirety, disclosed the following seven non-limiting exemplary embodiments:
A. A transparent ink-jet recording film comprising:

a transparent substrate comprising a polyester;

at least one subbing layer disposed on the transparent substrate, the at least one subbing layer comprising gelatin, at least one polymeric matting agent, and at least one borate or borate derivative; and

at least one image-receiving layer disposed on the at least one subbing layer, the at least one image-receiving layer comprising at least one water soluble or water dispersible polymer and at least one inorganic particle, the at least one water soluble or water dispersible polymer comprising at least one hydroxyl group.
B. The transparent ink-jet recording film according to embodiment A, further comprising at least one primer layer disposed between the transparent substrate and the at least one subbing layer, the at least one primer layer comprising at least one latex polymer and at least one adhesion promoter.
C. The transparent ink-jet recording film according to embodiment B, wherein the at least one adhesion promoter comprises resorcinol.
D. The transparent ink-jet recording film according to embodiment A, wherein the at least one polymeric matting agent comprises a copolymer comprising recurring units comprising methyl methacrylate.
E. The transparent ink-jet recording film according to embodiment A, wherein the at least one borate or borate derivative comprises sodium tetraborate decahydrate.
F. The transparent ink-jet recording film according to embodiment A, wherein the at least one water soluble or water dispersible polymer comprises poly(vinyl alcohol).
G. The transparent ink-jet recording film according to embodiment A, wherein the at least one inorganic particle comprises a boehmite alumina.

### EXAMPLES

### Materials

Materials used in the examples were available from Aldrich Chemical Co., Milwaukee, unless otherwise specified.

Boehmite is an aluminum oxide hydroxide (γ-AlO(OH)).

Borax is sodium tetraborate decahydrate.

CELVOL® 540 is a poly(vinyl alcohol) that is 87-89.9% hydrolyzed, with 140,000-186,000 weight-average molecular weight. It is available from Sekisui Specialty Chemicals America, LLC, Dallas, Tex.

DISPERAL® HP-14 is a dispersible boehmite alumina powder with high porosity and a particle size of 14 nm. It is available from Sasol North America, Inc., Houston, Tex.

Gelatin is a Regular Type IV bovine gelatin. It is available as Catalog No. 8256786 from Eastman Gelatine Corporation, Peabody, Mass..

KATHON® LX is a microbiocide. It is available from Dow Chemical.

Polyethylene terephthalate uncoated film was available from SKC, Inc., Covington, Ga.

Surfactant 10G is an aqueous solution of nonyl phenol, glycidyl polyether. It is available from Dixie Chemical Co., Houston, Tex..

VERSA-TL 502 is a sulfonated polystyrene (1,000,000 molecular weight). It is available from AkzoNobel.

### Example 1

### Preparation of Primer and First Subbing Coated Substrate

A primer mix was prepared comprising: 73.2 parts by weight water; 24.2 parts by weight of a terpolymer of monomers comprising about 83 wt % vinylidene chloride, about 15 wt % methyl acrylate, and about 2 wt % itaconic acid; 1.6 parts by weight of a 65.4% aqueous solution of saponin; and 1 part by weight resorcinol. This primer mix was applied at 50° C. to both sides of a polyethylene terephthalate web, which was then dried and stretched.

A first subbing mix was prepared comprising: 98.79 parts by weight water; 0.16 parts by weight potassium acetate; 0.84 parts by weight gelatin; 0.011 parts by weight saponin; 0.0075 parts by weight poly(methyl methacrylate-co-ethylene glycol dimethacrylate); and 0.00011 parts by weight chrome alum. This first subbing mix was applied at 50° C. to both sides of the primer coated polyethylene terephthalate web, which was then dried.

### Application of Second Subbing Coating Layer

A second subbing mix was prepared, by first adding to a mixing vessel a composition comprising: 98.79 parts by weight water; 0.16 parts by weight potassium acetate; 0.84 parts by weight gelatin; 0.011 parts by weight saponin; 0.0075 parts by weight poly(methyl methacrylate-co-ethylene glycol dimethacrylate); and 0.00011 parts by weight chrome alum. This mix was heated to 47° C. and agitated for 10 min. To this mix was added 3.64 parts borax (sodium tetraborate decahydrate). The mix was agitated for 30 min. To this mix was added 2.53 parts of a 10 wt % aqueous solution of nonyl phenol, glycidyl polyether (Surfactant 10G, Dixie). The mix was agitated for 10 min.

This second subbing mix was applied at 47° C. to the primer and subbing coated polyethylene terephthalate web. The web was moving continuously at 30 ft/sec and the coating mix feed rate was 16.1 g/min. The coated web was dried continuously by moving past perforated plates through which room temperature air flowed. The pressure drop across the perforated plates was about 0.8 in H₂O. The air dew point was in the range of 7 to 13° C. The resulting second subbing layer dry coating weight was 0.67 g/m², with a dry borax coverage of 0.48 g/m².

### Preparation of Alumina Mix

A nominal 30 wt % alumina mix was prepared at room temperature by mixing 310.5 parts of a 22 wt % aqueous solution of nitric acid and 7740 parts of demineralized water. To this mix, 3450 parts of alumina powder (DISPERAL® HP-14, Sasol) was added over 30 min. The pH of the mix was adjusted to 2.17 by adding additional nitric acid solution. The mix was heated to 80° C. and stirred for 30 min. The mix was cooled to room temperature and held for gas bubble disengagement prior to use.

### Preparation of Image-Receiving Layer Coating Mix

A nominal 26 wt % solids image-receiving coating mix was prepared at room temperature by introducing 2801 parts of a 10 wt % aqueous solution of poly(vinyl alcohol) (CELVOL® 540, Sekisui) into a mixing vessel and agitating. To this mix, 10739 parts of the alumina mix and 259.3 parts of a 10 wt % aqueous solution of nonyl phenol, glycidyl polyether (Surfactant 10G, Dixie) were added.

### Preparation of Image-Receiving Layer Coated Films

The nominal 25 wt % solids image-receiving layer coating mix was coated at a feed rate of 145.4 g/min to the second subbing layer of coated web, which was moving at a rate of 30 ft/sec. The coated web was dried continuously by moving past perforated plates through which room temperature air flowed. The pressure drop across the perforated plates was about 0.8 in H₂O. The air dew point was in the range of 7 to 13° C. The resulting image-receiving layer dry coating weight was 40.1 g/m². The image-receiving layer exhibited some patterning from the drying process. The coated substrate was cut into smaller coated films.

### Coated Film Adhesion Evaluation

Adhesion of the layers of one of the coated films was evaluated by scribing a cross-hatched area on the image-receiving side of the film with a razor blade and gently removing the debris with a lint-free cotton pad. Adhesive tape (#610 semi-transparent pressure-sensitive tape from 3M Company, St. Paul, Minn.) was then applied to the crosshatched area and smoothed with a rubber roller until there were no air bubbles between the tape and the coated film. The tape was then rapidly peeled off. The appearance of the coated film was given a score on a 0 to 5 scale: 5=edges of scribed cuts completely smooth; 4=flakes of coating detached at some intersections of scribed lines, with less than about 5% of the test area being affected; 3=flakes of coating detached along some edges and at some intersections of scribed lines, with about 5 to 15% of the test area being affected; 2=flakes of coating detached along some edges of scribed lines and on parts of the squares, with about 15 to 35% of the test area being affected; 1=coating detached along the edges of scribed lines in large ribbons, with more than about 35% of the test area being affected; 0=coating completely removed. The coated film was evaluated at 45-55% relative humidity and exhibited an adhesion value of 5.

### Coated Film Ink Drying Evaluation

Another one of the coated films was imaged with an EPSON® 7900 ink-jet printer using a Wasatch Raster Image Processor (RIP). A grey scale image was created by a combination of photo black, light black, light light black, magenta, light magenta, cyan, light cyan, and yellow EPSON® inks that were supplied with the printer. Samples were printed with a 17-step grey scale wedge having a maximum optical density of at least 2.8, as measured by a calibrated X-RITE® Model DTP 41 Spectrophotometer (X-Rite, Inc., Grandville, Mich.) in transmission mode.

Immediately after the film exited the printer, the ink-jet image was turned over and placed over a piece of white paper. The fraction of each wedge that was wet was recorded by sequential wedge number, with wedge 1 being the wedge having the maximum optical density and wedge 17 being the wedge with the minimum optical density. In general, the higher number wedges dried before the lowest number wedges.

A measure of wetness was constructed by taking the largest wedge number for the set of completely wet wedges and adding to it the fractional wetness of the adjacent wedge with the next higher wedge number. For example, if wedges 1 and 2 were completely wet and wedge 3 is 25% wet, the wetness value would be 2.25. Or if no wedges were completely wet, but wedge 1 was 75% wet, the wetness value would be 0.75.

The coated film was tested at 84-88% relative humidity and exhibited a maximum optical density of 3.295 and a wetness value of 4.5.

### Coated Film Haze Evaluation

Haze (%) of the coated film was measured in accord with ASTM D 103 by conventional means using a HAZE-GARD PLUS Hazemeter, available from BYK-Gardner (Columbia, Md.).

The coated film exhibited a haze value of 13.8%

### Example 2

The procedure of Example 1 was repeated, with the following changes. The second subbing layer coating mix feed rate was 32.5 g/min, which resulted in a dry coating weight of 1.37 g/m² and a dry borax coverage of 0.98 g/m². The image-receiving layer coating mix feed rate was 109.0 g/min, which resulted in a dry coating weight of 30.2 g/m.

The coated film image-receiving layer was free of patterning from the drying process. The film had an image-receiving layer side adhesion of 5, a wetness value of 5. a maximum optical density of 3.504, and a haze value of 11.1%.

### Example 3

The procedure of Example 1 was repeated, with the following changes. The second subbing layer coating mix feed rate was 32.5 g/min, which resulted in a dry coating weight of 1.37 g/m² and a dry borax coverage of 0.98 g/m². The image-receiving layer coating mix feed rate was 145.4 g/min, which resulted in a dry coating weight of 40.4 g/m.

The coated film image-receiving layer was free of patterning from the drying process. The film had an image-receiving layer side adhesion of 5, a wetness value of 4, a maximum optical density of 3.011, and a haze value of 13.5%.

### Example 4 (Comparative)

A nominal 30 wt % alumina mix was prepared at room temperature by mixing 310 g of a 22 wt % aqueous solution of nitric acid and 7740 g of deionized water. To this mix, 3450 g of alumina powder (DISPERAL® HP-14) was added over 30 min. The pH of the mix was adjusted to 2.17 by adding an additional 15 g of the nitric acid solution. The mix was heated to 80° C. and stirred for 30 min. The mix was cooled to room temperature and held for gas bubble disengagement prior to use. The cooled mix had a pH of 2.73.

A nominal 26 wt % image-receiving coating mix was prepared at room temperature by introducing 2801 g of a 10 wt % aqueous solution of poly(vinyl alcohol) (CELVOL® 540) into a mixing vessel and agitating. To this mix, 10739 g of the 30 wt % alumina mix and 259 g of a 10 wt % aqueous solution of nonyl phenol, glycidyl polyether (Surfactant 10G) was added. The mix was cooled to room temperature and held for gas bubble disengagement prior to use. This mix had a viscosity of 83.5 cP at 40° C.

A nominal 9.2 wt % under-layer coating mix was prepared at room temperature by introducing 4793 g of deionized water to a mixing vessel. 360 g of gelatin was added to the agitated vessel and allowed to swell. This mix was heated to 60° C. and held until the gelatin was fully dissolved. The mix was then cooled to 50° C. To this mix, 162 g of borax (sodium tetraborate decahydrate) was added and mixed until the borax was fully dissolved. To this mix, 562 g of an aqueous solution of 3.2 wt % sulfonated polystyrene (VERSA-TL 502, AkzoNobel) and 0.2 wt % microbiocide (KATHON® LX, Dow) was added and mixed until homogeneous. The mix was then cooled to 40° C. 123 g of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The ratio of borax to gelatin in the resulting under-layer coating mix was 0.45:1 by weight. This mix had a viscosity of 64.3 cP at 40° C.

The under-layer coating mix was heated to 40° C. and applied continuously to a room temperature blue-tinted polyethylene terephthalate web, which was moving at a speed of 30.0 ft/min. An under-layer coating mix feed rate of 28.8 g/min was used to provide an under-layer with a dry coating weight of 2.90 g/m² and a dry borate coverage of 0.85 g/m². The coated web was dried continuously by moving past perforated plates through which room temperature air flowed. The pressure drop across the perforated plates was 0.8 in H₂O. The air dew point ranged from 7 to 13° C.

The image-coating mix was heated to 40° C. and coated onto the under-layer coated surfaces of the room temperature polyethylene terephthalate web, which was moving at a speed of 30.0 ft/min. An image-receiving coating mix feed rates of 109.0 g/min was used. The coated film was dried continuously by moving past perforated plates through which room temperature air flowed. The pressure drop across the perforated plates was 0.8 in H₂O. The air dew point ranged from 7 to 13° C. The dried image-receiving layer coating weight was 30.3 g/m².

The coated film was evaluated according to the methods of Example 1. The coated film image-receiving layer was free of patterning from the drying process. The film had an image-receiving layer side adhesion of 5, a wetness value of 5, a maximum optical density of 3.233, and a haze value of 15.7%.

Note that this film exhibited 4.6% higher haze than the film of Example 2, which had similar dry borax coverage, image-receiving layer coating weight, adhesion value, and wetness value.

### Example 5 (Comparative)

A nominal 30 wt % alumina mix was prepared at room temperature by mixing 310 g of a 22 wt % aqueous solution of nitric acid and 7740 g of deionized water. To this mix, 3450 g of alumina powder (DISPERAL® HP-14) was added over 30 min. The pH of the mix was adjusted to 2.17 by adding an additional 15 g of the nitric acid solution. The mix was heated to 80° C. and stirred for 30 min. The mix was cooled to room temperature and held for gas bubble disengagement prior to use. The cooled mix had a pH of 2.73.

A nominal 26 wt % image-receiving coating mix was prepared at room temperature by introducing 2801 g of a 10 wt % aqueous solution of poly(vinyl alcohol) (CELVOL® 540) into a mixing vessel and agitating. To this mix, 10739 g of the 30 wt % alumina mix and 259 g of a 10 wt % aqueous solution of nonyl phenol, glycidyl polyether (Surfactant 10G) was added. The mix was cooled to room temperature and held for gas bubble disengagement prior to use. This mix had a viscosity of 83.5 cP at 40° C.

A nominal 9.2 wt % under-layer coating mix was prepared at room temperature by introducing 4793 g of deionized water to a mixing vessel. 360 g of gelatin was added to the agitated vessel and allowed to swell. This mix was heated to 60° C. and held until the gelatin was fully dissolved. The mix was then cooled to 50° C. To this mix, 162 g of borax (sodium tetraborate decahydrate) was added and mixed until the borax was fully dissolved. To this mix, 562 g of an aqueous solution of 3.2 wt % sulfonated polystyrene (VERSA-TL 502, AkzoNobel) and 0.2 wt % microbiocide (KATHON® LX, Dow) was added and mixed until homogeneous. The mix was then cooled to 40° C. 123 g of a 10 wt % aqueous solution of nonyl phenol, glycidyl polyether (Surfactant 10G) was then added and mixed until homogeneous. This mix was cooled to room temperature and held to allow disengagement of any gas bubbles prior to use. The ratio of borax to gelatin in the resulting under-layer coating mix was 0.45:1 by weight. This mix had a viscosity of 64.3 cP at 40° C.

The under-layer coating mix was heated to 40° C. and applied continuously to a room temperature blue-tinted polyethylene terephthalate web, which was moving at a speed of 30.0 ft/min. An under-layer coating mix feed rate of 28.8 g/min was used to provide an under-layer with a dry coating weight of 2.90 g/m² and a dry borate coverage of 0.85 g/m². The coated web was dried continuously by moving past perforated plates through which room temperature air flowed. The pressure drop across the perforated plates was 0.8 in H₂O. The air dew point ranged from 7 to 13° C.

The image-coating mix was heated to 40° C. and coated onto the under-layer coated surfaces of the room temperature polyethylene terephthalate web, which was moving at a speed of 30.0 ft/min. An image-receiving coating mix feed rates of 145.4 g/min was used. The coated film was dried continuously by moving past perforated plates through which room temperature air flowed. The pressure drop across the perforated plates was 0.8 in H₂O. The air dew point ranged from 7 to 13° C. The dried image-receiving layer coating weight was 40.3 g/m².

The coated film was evaluated according to the methods of Example 1. The coated film image-receiving layer was free of patterning from the drying process. The film had an image-receiving layer side adhesion of 5, a wetness value of 4, a maximum optical density of 3.111, and a haze value of 16.8%.

Note that this film exhibited 3.3% higher haze than the film of Example 3, which had similar dry borax coverage, image-receiving layer coating weight, adhesion value, and wetness value.

### Example 6 (Prophetic)

### Preparation of Primer and Subbing Coated Substrate

A first mix is prepared comprising: 73.2 parts by weight water; 24.2 parts by weight of a terpolymer of monomers comprising about 83 wt % vinylidene chloride, about 15 wt % methyl acrylate, and about 2 wt % itaconic acid; 1.6 parts by weight of a 65.4% aqueous solution of saponin; and 1 part by weight resorcinol. This first mix is applied at 50° C. to both sides of a polyethylene terephthalate web, which is then dried and stretched.

A second mix is prepared comprising: 98.79 parts by weight water; 0.16 parts by weight potassium acetate; 0.84 parts by weight gelatin; 3.6 parts by weight borax; 0.011 parts by weight saponin; 0.0075 parts by weight poly(methyl methacrylate-co-ethylene glycol dimethacrylate); and 0.00011 parts by weight chrome alum. This second mix is applied at 50° C. to both sides of the primer coated polyethylene terephthalate web.

This subbing-coated substrate is dried and cut into smaller subbing-coated films for lab coating.

### Preparation of Alumina Mix

A nominal 20 wt % alumina mix is prepared at room temperature by mixing 4 g of a 22 wt % aqueous solution of nitric acid and 556 g of deionized water. To this mix, 140 g of alumina powder (DISPERAL® HP-14, Sasol) is added over 30 min. The pH of the mix is adjusted to 3.25 by adding additional nitric acid solution. The mix is heated to 80° C. and stirred for 30 min. The mix is cooled to room temperature and held for gas bubble disengagement prior to use.

### Preparation of Image-Receiving Layer Coating Mix

A nominal 18 wt % solids image-receiving coating mix is prepared at room temperature by introducing 7.13 g of a 10 wt % aqueous solution of poly(vinyl alcohol) (CELVOL® 540, Sekisui) into a mixing vessel and agitating. To this mix, 41.00 g of the alumina mix, 0.66 g of a 10 wt % aqueous solution of nonyl phenol, glycidyl polyether (Surfactant 10G, Dixie), and 1.00 g of deionized water are added.

### Preparation of Image-Receiving Layer Coated Films

The nominal 18 wt % solids image-receiving layer coating mix is knife-coated at room temperature onto the subbing-coated films, using a coating gap of 12 mils. The coated films are dried at 50° C. for 10 min in a Blue M Oven. The resulting image-receiving layer has a dry coating weight of 44.3 g/m².

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A transparent ink-jet recording film comprising:
a transparent substrate comprising a polyester;
at least one subbing layer disposed on the transparent substrate, the at least one subbing layer comprising gelatin, at least one polymeric matting agent, and at least one borate or borate derivative; and
at least one image-receiving layer disposed on the at least one subbing layer, the at least one image-receiving layer comprising at least one water soluble or water dispersible polymer and at least one inorganic particle, the at least one water soluble or water dispersible polymer comprising at least one hydroxyl group.

2. The transparent ink-jet recording film according to claim 1, further comprising at least one primer layer disposed between the transparent substrate and the at least one subbing layer, the at least one primer layer comprising at least one latex polymer and at least one adhesion promoter.

3. The transparent ink-jet recording film according to claim 2, wherein the at least one adhesion promoter comprises resorcinol.

4. The transparent ink-jet recording film according to claim 1, wherein the at least one polymeric matting agent comprises a copolymer comprising recurring units comprising methyl methacrylate.

5. The transparent ink-jet recording film according to claim 1, wherein the at least one borate or borate derivative comprises sodium tetraborate decahydrate.

6. The transparent ink-jet recording film according to claim 1, wherein the at least one water soluble or water dispersible polymer comprises poly(vinyl alcohol).

7. The transparent ink-jet recording film according to claim 1, wherein the at least one inorganic particle comprises boehmite alumina.
